(19) United States
(12) Patent Application Publication
(10) Pub. No.: US 2025/0066092 A1
(43) Pub. Date: Feb. 27, 2025

(54) Direct-Mold Blister Packaging System for Chocolate and Gummy Products

(71) Applicants: Daniel Genovese, San Jose, CA (US); David Genovese, San Jose, CA (US)

(72) Inventors: Daniel Genovese, San Jose, CA (US); David Genovese, San Jose, CA (US)

(73) Assignee: Day Dreamers Confections, San Jose, CA (US)

(21) Appl. No.: 18/238,005

(22) Filed: Aug. 25, 2023

(51) Int. Cl. B65D 75/36; A23G 1/00; B65B 9/04; B65D 81/30

(52) U.S. Cl. CPC B65D 75/367; A23G 1/0079; B65B 9/04; B65D 81/30; B65D 2575/3209

(57) ABSTRACT

The Direct-Mold Blister Packaging System for Chocolate and Gummy Products provides an integrated method and apparatus for the production and packaging of confectionery items. The system enables pouring of molten chocolate or gummy mixture directly into custom plastic molds. These molds not only shape the confections but also form part of the final packaging. After the confections solidify, a metallic film is used to overlay and seal the molds, ensuring prolonged freshness and protection. This film also enhances the visual appeal of the package. The packaging system combines the molding and packaging stages into one, offering advantages like shape retention, precise dosage control, and waste reduction

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present invention relates to packaging systems, and more particularly, to a direct-mold blister packaging system designed for the efficient production, storage, and distribution of chocolate and gummy products. The invention involves a method of pouring chocolates or gummies directly into plastic molds, solidifying them, and sealing with a metallic film. This enhances the product's quality, appearance, and overall manufacturing efficiency. The packaging system is particularly suitable for a range of confectionery products, including those requiring precise dosages of active ingredients, such as medicinal or specialized confections.

### Description of the Related Art

The packaging of chocolate and gummy products has always been crucial for manufacturers, retailers, and consumers. Effective packaging should protect the contents from external contaminants, moisture, and temperature fluctuations, while also boosting the product's visual appeal, accessibility, and ease of consumption. Numerous methods, some patented, have been proposed to address these requirements for chocolates and gummies.

The first invention (BE1017445A6) offers a method where chocolate is poured directly into a mold, which then becomes a part of the final packaging. This resembles the proposed Direct-Mold Blister Packaging System but has distinct differences. The latter introduces a metallic film that acts both as a seal and reflective surface, adding to the product's aesthetics. It also ensures superior form retention at elevated temperatures and exact dosage for medicinal confections.

The second invention (BE1021286B1) details the packaging of filled chocolates, placing the chocolate on a support, encasing it with a film, and subsequently sealing it. This technique is different from the proposed one which centers on directly molding the confectionery in the packaging. Besides, the proposed method incorporates a metallic film seal, customization options, minimizes waste, and provides accurate dosage control—attributes not mentioned in this patent.

The third invention (CN213798534U) zeroes in on a unique type of film for packaging confectioneries, underlining the materials used in the film layers. Even though the proposed invention incorporates a metallic film, it's part of an all-encompassing process of direct-mold packaging, differentiating it from this invention.

The fourth invention (EP1918094B1) highlights a specialized packaging foil for confections, tailored for molded products with convex and concave shapes. The proposed method stands out by molding the confectionery directly into the packaging, an aspect not detailed in this patent.

The fifth invention (KR100922490B1) focuses on a film for blister packaging with an absorption and barrier layer, mainly emphasizing the film's materials and structure. The proposed packaging system stands apart with its stress on the direct-mold packaging technique, offering perks like quality assurance, waste reduction, and exact dosage for medicinal confections.

Summing up, the proposed Direct-Mold Blister Packaging System brings together unique features not found in the studied patents, merging aspects like direct molding in the final packaging, metallic film sealing, and precise dosage control. This positions it as a pioneering solution in the packaging realm for chocolate and gummy products.

### SUMMARY OF THE INVENTION

The present invention, termed the Direct-Mold Blister Packaging System, pioneers an inventive method and apparatus for packaging both chocolate and gummy products. This innovation uniquely fuses the molding and packaging stages of these confections into a singular, cohesive process. This integration is facilitated by directly pouring either molten chocolate or gummy mixture into custom-engineered plastic molds, which then seamlessly transition to become components of the ultimate packaging. Such a design obviates the need for distinct molding and subsequent packaging phases.

After allowing the chocolate or gummy to set within these molds, a metallic film overlays the molds, securing the confectionery to ensure its prolonged freshness and impeccable quality. Beyond its primary function, this film serves as a formidable shield against potential external hazards, spanning from air and moisture to intrusive light, simultaneously enhancing the packaging with its lustrous, aesthetically pleasing finish.

The innovation presents a plethora of unparalleled advantages. These range from exceptional shape retention, even under elevated temperatures, to meticulous dosage control pivotal for medicinal or specialized confections. The system also champions sustainability by curbing waste and amplifies the scope for detailed confectionery designs, thanks to the direct molding capability. Conclusively, the Direct-Mold Blister Packaging System heralds a holistic, efficient, and superior packaging alternative for both chocolate and gummy products, marking its versatility across diverse segments of the confectionery domain.

### DESCRIPTION OF THE DRAWINGS

The ensuing drawings serve to illustrate the Direct-Mold Blister Packaging System, meticulously detailing its distinctive components and their synergistic assembly. These depictions encompass the integral facets of the packaging system: the bespoke plastic mold, the confections (be they chocolate or gummy), and the metallic film seal.

FIG. 1 unveils an exploded view, meticulously deconstructing the Direct-Mold Blister Packaging System. This diagram distinctly displays the custom plastic mold, the confections-chocolate or gummy, and the metallic film, elucidating how each component seamlessly dovetails with the others, orchestrating the culmination of the final packaging.

FIG. 2 offers a vantage perspective of the top view, underscoring the mold's design and the confections' tailored contours as they're precisely cast within the mold. This perspective elucidates the aesthetic profile when viewed from above, accentuating the mold's capacity to sculpt the confections.

FIG. 3, contrarily, presents a perspective of the bottom view, emphasizing the metallic film's pivotal role. This perspective elucidates the film's dual functionalities: its reflective sheen amplifying the packaging's aesthetic allure, and its robust nature safeguarding the confections within their plastic encasement.

### REFERENCE NUMERALS IN THE DRAWINGS

The figures incorporate reference numerals to meticulously delineate the integral components of the Direct-Mold Blister Packaging System for Chocolate or Gummy Products. As detailed below:
100. Direct-Mold Blister Packaging System for Chocolate or Gummy Products
110. Custom-designed plastic mold
120. Individual compartments within the mold
130. Confection pieces (either chocolate or gummies)
140. Metallic film

Each reference numeral epitomizes a distinct facet of the packaging system and consistently recurs throughout the patent application, providing a lucid and systematic nomenclature for the components and hallmark features of the invention.

### DETAILED DESCRIPTION OF THE INVENTION

At the epicenter of this patent lies the ingenious concept: The Direct-Mold Blister Packaging System for Chocolate or Gummy Products, aptly numbered as 100. It harmonizes the creation and containment of confectionery items, offering both an innovative approach to molding and a robust packaging solution.

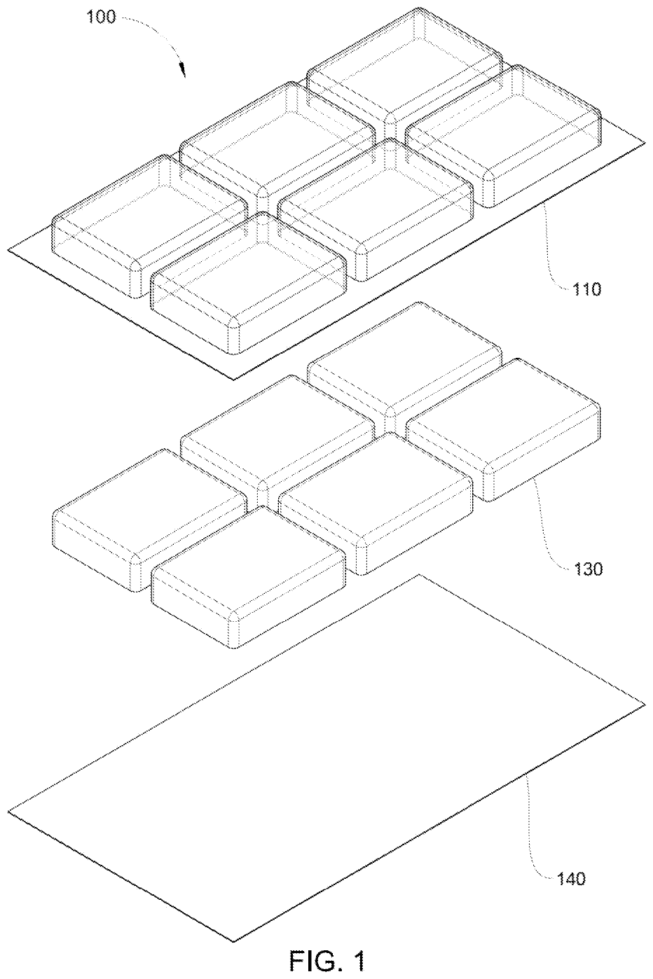

FIG. 1: This illustration provides an exploded view, meticulously laying out the fundamental components of the invention. Front and center is the Direct-Mold Blister Packaging System (100). This framework includes the custom-designed plastic mold (110) that sets the stage for the shape and form of the confections. Then, there are the actual confections themselves-either delectable chocolate or gummy pieces (130) that are destined to reside within the mold's confines. Bringing up the rear and ensuring everything remains pristine and protected is the metallic film (140), a guardian shield that both seals and showcases the contents within.

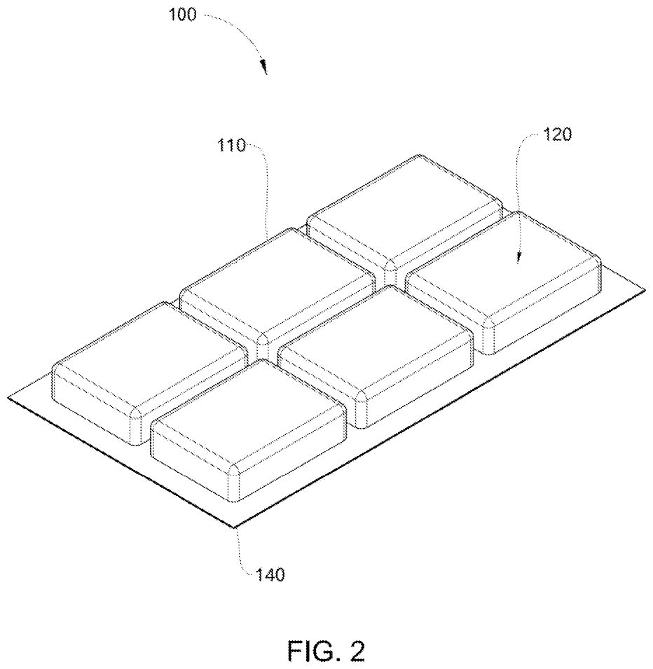

FIG. 2: As we transition to this figure, our vantage point shifts to a top-down perspective, offering a bird's eye view of the packaging system. In this angle, the Direct-Mold Blister Packaging System (100) lays out its key components in full glory. The custom-designed plastic mold (110) stands out, revealing its inner workings, the individual compartments (120). These compartments are the heart of the customization process, allowing for a diverse array of confection shapes. Draped over it all, almost like a protective blanket, is the metallic film (140). Its presence here not only amplifies the aesthetic appeal but serves as an initial insight into its sealing capabilities.

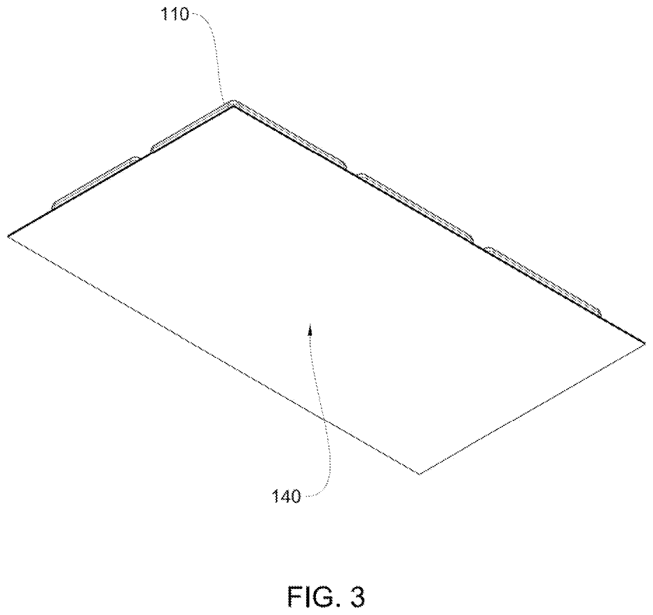

FIG. 3: The narrative takes a twist with this figure. We're now introduced to the bottom perspective, almost like peering from beneath. Yet, even from this angle, certain components assert their dominance. The custom-designed plastic mold (110) re-emerges, showing its adaptability to various viewpoints. And, just as in the previous figures, the metallic film (140) makes its presence felt. From this perspective, it further emphasizes its role in providing a foundational seal and barrier, reiterating its importance in the overall packaging system.

In essence, this Direct-Mold Blister Packaging System for Chocolate or Gummy Products (100) is a testament to modern-day packaging innovation. It doesn't just serve a singular purpose but merges multiple functionalities, from shaping confections to ensuring their preservation. Every figure, every component, and every number plays a pivotal role in telling this story. Manufacturers and confectionery enthusiasts alike can revel in the advantages and aesthetics that this system brings to the table.

1. A direct-mold blister packaging system for chocolate or gummy products comprising:
a custom-designed plastic mold for shaping and containing the confectionery products;
individual compartments within the mold designed for the formation of specific shapes of confections;
confection pieces formed within said mold, wherein the confection pieces can be either chocolate or gummies; and
a metallic film overlaid onto said mold for sealing and protecting the confections therein.

2. The direct-mold blister packaging system as claimed in claim 1, wherein the molten chocolate or gummy mixture is poured directly into the custom-designed plastic mold, eliminating the need for separate molding and packaging processes.

3. The direct-mold blister packaging system as claimed in claim 1, wherein the metallic film provides a barrier against external contaminants, including moisture, air, and light.

4. The direct-mold blister packaging system as claimed in claim 1, wherein the metallic film enhances the visual aesthetics of the packaging through its reflective properties.

5. A method of packaging chocolate or gummy products using the direct-mold blister packaging system, the method comprising the steps of:
pouring molten chocolate or gummy mixture into the custom-designed plastic mold;
allowing the mixture to solidify within the mold, forming confection pieces;
overlaying the mold with a metallic film; and
sealing the confection pieces within the mold using said metallic film.

6. The method as claimed in claim 5, wherein the direct pouring into the mold ensures accurate dosage control, particularly beneficial for medicinal or specialized confections.

7. The method as claimed in claim 5, wherein the utilization of the custom-designed plastic mold with individual compartments enables the creation of intricate and detailed confectionery designs.

8. The method as claimed in claim 5, wherein the metallic film acts as a shield against potential hazards, preserving the freshness and quality of the confections.

9. The method as claimed in claim 5, further comprising the step of displaying the confections through the metallic film, leveraging its reflective property for enhanced visual appeal.

10. The direct-mold blister packaging system as claimed in claim 1, wherein the system offers advantages of minimized waste, enhanced product quality, and sustainability.
